(19) United States
(12) Patent Application Publication
(10) Pub. No.: US 2020/0207295 A1
(43) Pub. Date: Jul. 2, 2020

(54) METHODS AND SYSTEMS TO PREVENT UNINTENDED SHUT DOWN OF VEHICLE SYSTEMS

(71) Applicant: Continental Automotive Systems Inc., Auburn Hills, MI (US)

(72) Inventors: Amit B. Kapoor, Rochester, MI (US); Bob M. Andres, Clarkston, MI (US)

(21) Appl. No.: 16/672,846

(22) Filed: Nov. 4, 2019

Related U.S. Application Data
(60) Provisional application No. 62/784,875, filed on Dec. 26, 2018.

(51) Int. Cl. B60R 16/03; B60W 40/105; B60R 21/017; B60W 30/02; B60W 10/18; B60W 10/20

(52) U.S. Cl. CPC B60R 16/03; B60W 40/105; B60R 21/017; B60W 2510/0657; B60W 10/18; B60W 10/20; B60W 30/02

(57) ABSTRACT

A vehicle power control system includes a controller mounted within the vehicle, which is configured to monitor a condition of a switch controlling vehicle power and a vehicle speed. The controller is configured to maintain power to at least one vehicle system in response to the switch being in a power off condition and the vehicle speed being above a predefined threshold speed.

### TECHNICAL FIELD

The present disclosure relates to systems and methods that prevent an unintended loss of power to vehicle operating and/or safety systems.

### BACKGROUND

Vehicles include safety systems that are enabled based on a position of an ignition switch. When the ignition switch is in a run or crank position all systems are enabled. When the ignition switch is in an off position, all vehicles systems are shut down based on the assumption that the vehicle operator had both moved the ignition switch and intended to shut down the vehicle. In some situations, the systems may need to be shut down when the vehicle is not operating to prevent battery drain or unintended actuation of safety devices.

An unintended shut down of vehicle systems can result in a loss of power steering, electronic braking, and electronic stability control. Moreover, safety systems, including the restraint and airbag systems, may also be shut down.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A vehicle power control system, according to an example of this disclosure, includes a controller mounted within the vehicle and configured to monitor a condition of a switch controlling vehicle power and a vehicle speed. The controller is configured to maintain power to at least one vehicle system in response to the switch being in a power off condition and the vehicle speed being above a predefined threshold speed.

In a further example of the foregoing, at least one vehicle system comprises one a vehicle control system.

In a further example of any of the foregoing, at least one vehicle system includes one a vehicle safety system.

In a further example of any of the foregoing, at least one vehicle system includes a power brake system.

In a further example of any of the foregoing, at least one vehicle system is a power steering system.

In a further example of any of the foregoing, at least one vehicle system is a stability control system.

In a further example of any of the foregoing, at least one vehicle system is an active restraint system.

In a further example of any of the foregoing, at least one vehicle system is an airbag system.

In a further example of any of the foregoing, a vehicle includes the vehicle power control system.

A method of preventing unintended loss of power to a vehicle system according to an example of this disclosure, includes monitoring a switch controlling vehicle power, sensing a parameter of the vehicle in response to the switch moving to a power off position, and maintaining power to at least one vehicle system in response to the sensed vehicle parameter being in a predefined condition.

In a further example of the foregoing, the parameter is vehicle speed.

In a further example of any of the foregoing, at least one vehicle system includes one of a vehicle control system and an occupant restraint system.

In a further example of any of the foregoing, the method includes sensing the amount of time the vehicle is below the predefined threshold speed.

In a further example of any of the foregoing, the method includes shutting down power to at least one vehicle system in response to the sensed amount of time being above a predefined threshold time.

In a further example of any of the foregoing, the predefined threshold time is about 5 seconds.

In a further example of any of the foregoing, the predefined threshold speed is about 3 km/h.

In a further example of any of the foregoing, the parameter is engine torque.

In a further example of any of the foregoing, wherein the parameter is RPM.

In a further example of any of the foregoing, the parameter is transmission status in “Park”.

### BRIEF DESCRIPTION OF THE DRAWINGS

FIG. 1 is a schematic view of an example vehicle.

FIG. 2 is a schematic view of an example vehicle cabin.

FIG. 3 is a block diagram of a disclosed method of preventing unintended loss of power to vehicle systems.

### DETAILED DESCRIPTION

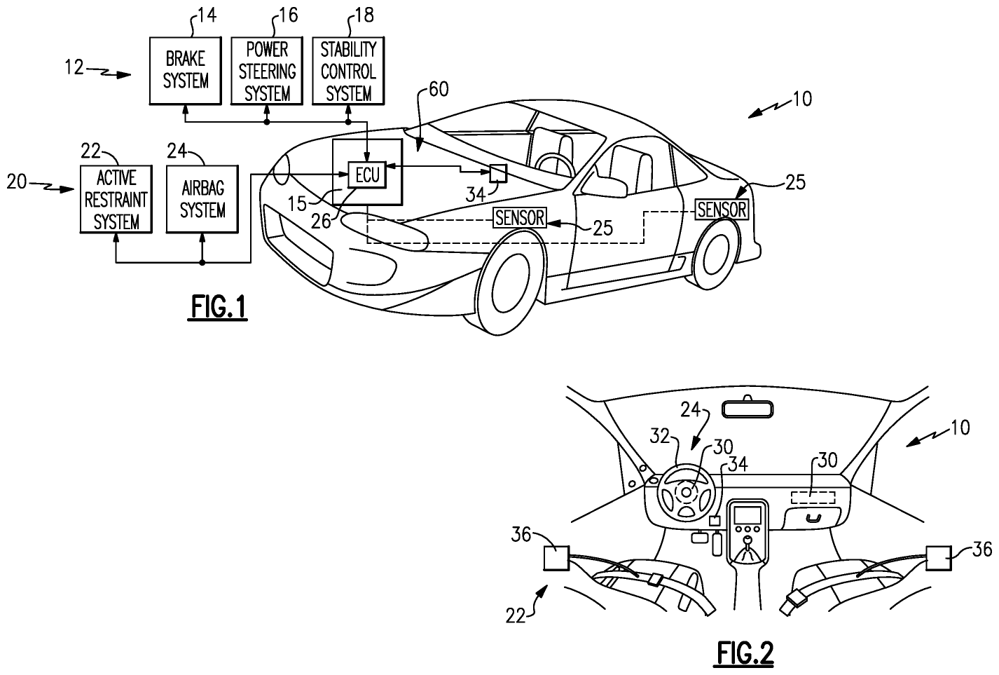

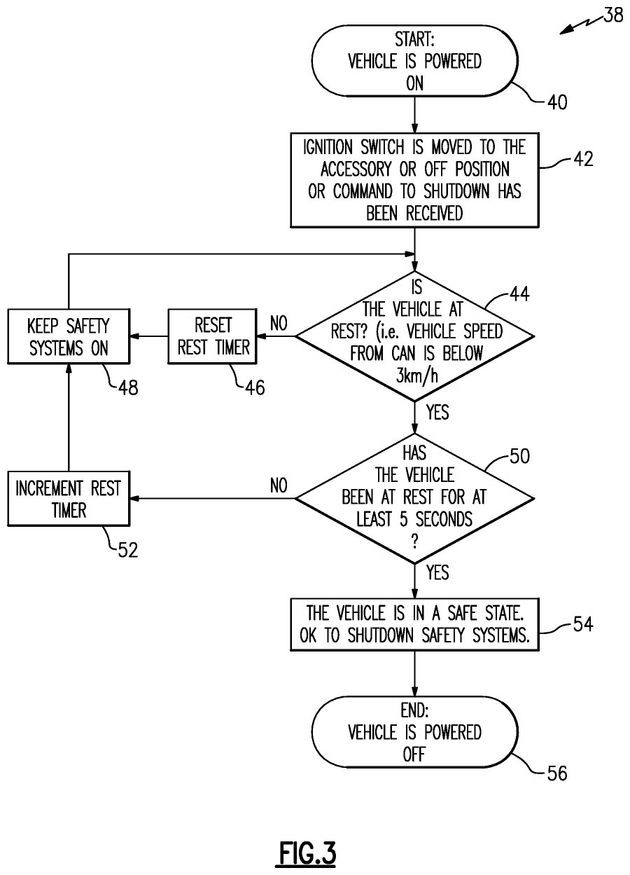

Referring to FIGS. 1 and 2, a motor vehicle 10 is schematically shown and includes vehicle operating systems 12 and vehicle safety systems 20. In some examples, as shown, the vehicle operating system 12 can include, among other possible things, a power brake system 14, a power steering system 16, and a stability control system 18. In some examples, as shown, the safety systems 20 can include, among other possible things, an active restraint system 22 and an airbag system 24. In some examples, the airbag system 24 is part of a passive restraint system of the vehicle 10. The various systems can be controlled by individual control units and/or a single central electronic control unit (ECU) mounted within the vehicle 10. A single central ECU 26 is disclosed by way of example and represents schematically various control modules disposed throughout the vehicle 10.

In some examples, as shown in FIG. 2, the interior of the vehicle 10 includes airbags 30 as part of the airbag system 24 and disposed within a dashboard and steering wheel 32. In some examples, as shown, the active restraint system 22 may include actuators 36 that operate in concert with the seat belts. An ignition or power switch 34 is disposed within the vehicle 10 cabin and controls starting and shutting down of the vehicle.

Referring back to FIG. 1, the example vehicle 10 includes a network (CAN bus) 15 which allows the ECUs of the various electronic subsystems to share information. In some examples, an ECU of the brake system 14 monitors information from wheel speed sensor 25 to determine the optimum control of the brake pressure during braking situations. The ECU 26 may also use the wheel speed information to calculate a vehicle speed which can be shared over the CAN bus 15 to be used by the various control modules of the vehicle 10. The vehicle speed information can be used to determine that the vehicle 10 is still in motion and therefore unsafe to power down critical safety systems.

The example vehicle 10 includes a system 60 for preventing an unintended shutdown of critical safety systems due to unintended actuation of the switch 34. The example switch 34 may be an ignition switch or a push button power switch or any other control that is utilized to shut down operation of a vehicle. In some examples, as shown, the system 60 is implemented as a program stored and operated by the ECU 26 mounted within the vehicle. In some examples, the example system 60 may be part of a central vehicle controller or provided as a portion of each system controller. A controller, in some examples, may include one or more computing devices, each having one or more of a computer processor, memory, storage means, network device and input and/or output devices and/or interfaces. A person of ordinary skill in the art having the benefit of this disclosure would recognize that various control unit configurations may be utilized with the system 60.

The vehicle operating systems 12 and safety systems 20 should remain operational if the vehicle is in motion, regardless of the position of the switch 34. Even if the switch 34 is in a position commanding shut down of the vehicle 10, the disclosed system 60 maintains power to vehicle systems 12, 20 until the vehicle is safely at a stop.

The disclosed system 60 prevents power shut off to vehicle systems such that the vehicle operator is able to maintain use of operating systems 12 to bring the vehicle 10 to a safe state of rest and also maintains operation of the safety systems 20.

One disclosed example embodiment of the system 60 uses information obtained by various vehicle systems to determine if the vehicle is in a safe condition for shutdown. In one disclosed embodiment, a vehicle speed threshold is determined by the various sensors and power is maintained until the vehicle 10 is below the speed threshold. It should be appreciated that although a vehicle speed threshold is disclosed by way of example, other operational parameters that are indicative of vehicle operation could additionally or alternatively be utilized and are within the contemplation of this disclosure. In some examples, one or more of engine torque, RPM, or transmission gear status may be operational parameters that are indicative of vehicle operation.

Referring to FIG. 3, with continued reference to FIGS. 1 and 2, an example embodiment of the disclosed method of preventing unintended power loss to vehicle systems is schematically indicated at 38. The method 38 begins with the vehicle 10 in an initial powered condition indicated at 40. In some examples, in the powered condition, the ignition switch 34 (see FIGS. 1 and 2) is powered ON (Ignition switch 34 in RUN position) and the vehicle 10 is being operated by a driver.

As indicated at 42, the system 60 recognizes when the ignition switch 34 is moved to a power off position either intentionally by the driver or unintentionally, such as due to a complex crash event or other situation in some examples. Before shutting down, the ECU 26 performs a check to assure that vehicle operating conditions are in a condition to safely shut down. In some examples, as shown, the system 60 the criteria required to enable vehicle 10 shut down is that the vehicle 10 is at rest for a predefined period of time, as is indicated at 44.

In some examples, as shown, the criteria used to determine if a vehicle is safe to shut down is that the predefined vehicle speed is below 3 km/ hour (1.9 mph) to determine if the vehicle is at rest. In some examples, as indicated at 50, the method 38 also requires that the vehicle 10 be at rest for a period of 5 seconds before the safety subsystems 20 are shut down. In some examples, vehicle operation is measured and monitored with information provided over the CAN bus 15 (see FIGS. 1 and 2), such as wheels speeds and/or engine torque, could also be used to determine if the vehicle 10 is in motion.

The disclosed threshold of 3 km/h and the time of 5 seconds are exemplary, and other parameters could be adapted to fit a vehicle's specific characteristics and are within the contemplation of this disclosure. In some examples, the threshold speed is between 1 and 5 km/h. In some examples, the threshold time is between 3 and 10 seconds.

In some examples, the time delay helps maintain operation of the operation systems 12 and safety systems 20 to provide occupant protection and driver control in the case of possible crash events. In some examples, if a vehicle 10 is hit, the disclosed system 60 will maintain operation of the safety systems 20 to provide protection for possible subsequent impact events. In some examples, each of the operating systems 12 and safety systems 20 could shut down after different delay periods to provide a phased shut down with the safety systems 20 shutting down last.

In some examples, as shown, a timer 46 may be actuated if the initial shutdown criteria indicated at 44 are not fulfilled. While the rest timer is greater than zero, the safety systems 48 will remain active and the system 60 will determine again if the criteria for vehicle shut down are meet as indicated at 44. Once the vehicle speed is below the threshold value, the delay period will be tolled as is indicated at 50. If the vehicle 10 does not reach the rest condition, or begins moving again within the delay period, the rest timer is reset as is indicated at 46. Upon expiration of the timer indicated at 54, the system 60 is safe for shutting down at 56.

In this disclosed example, once the vehicle 10 is below the predefined speed threshold value as indicated at 44 for the entire delay period as indicated at 50 a determination will be made that the vehicle 10 is ready for shutdown as is indicated at 54. The system 60 will then shutdown the vehicle 10 and each of the systems as is indicated at 56.

It should be understood that other criteria could be utilized to determine that vehicle shutdown is intended and that the vehicle 10 is in a safe condition to be shut down. In some examples, shut down can be determined to be intended in response to the driver door opening after the commanded shut down. In some examples, opening of the driver door may signal that the driver has finished driving and is intending to exit the vehicle. In some examples, information from an occupant detection system could be used to recognize if the driver's seat becomes unoccupied after commanded shut down.

Accordingly, in some examples, the disclosed system 60 and method 38 prevent unintended loss of power to vehicle safety and operating systems 12, 20 while the vehicle 10 is in motion. Information from the vehicle's CAN bus 15, such as vehicle speed in some examples, is used to determine that the vehicle 10 is still in motion. While the vehicle 10 is still in motion, the safety systems 20 and operating systems 12 will remain active. In some examples, the operating systems 12 may include the power steering system 16, the brake system 14, and the stability control system 18. The safety systems 20 may include active restraint control and airbag systems 22, 24. Power to the vehicle 10 is safely shut down in response to the determination that the vehicle 10 is safely at rest for a predefined period of time.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A vehicle power control system comprising:
a controller mounted within the vehicle configured to monitor a condition of a switch controlling vehicle power and a vehicle speed, wherein the controller is configured to maintain power to at least one vehicle system in response to the switch being in a power off condition and the vehicle speed being above a predefined threshold speed.

2. The vehicle power control system as recited in claim 1, wherein the at least one vehicle system comprises one a vehicle control system.

3. The vehicle power control system as recited in claim 1, wherein the at least one vehicle system comprises one a vehicle safety system.

4. The vehicle power control system as recited in claim 1, wherein the at least one vehicle system comprises a power brake system.

5. The vehicle power control system as recited in claim 1, wherein the at least one vehicle system is a power steering system.

6. The vehicle power control system as recited in claim 1, wherein the at least one vehicle system is a stability control system.

7. The vehicle power control system as recited in claim 1, wherein the at least one vehicle system is an active restraint system.

8. The vehicle power control system as recited in claim 1, wherein the at least one vehicle system is an airbag system.

9. A vehicle including the vehicle power control system as recited in claim 1.

10. A method of preventing unintended loss of power to a vehicle system, the method comprising:
monitoring a switch controlling vehicle power;
sensing a parameter of the vehicle in response to the switch moving to a power off position; and
maintaining power to at least one vehicle system in response to the sensed vehicle parameter being in a predefined condition.

11. The method as recited in claim 10, wherein the parameter is vehicle speed.

12. The method as recited in claim 10, wherein the at least one vehicle system comprises one of a vehicle control system and an occupant restraint system.

13. The method as recited in claim 11, the method comprising:
sensing the amount of time the vehicle is below the predefined threshold speed.

14. The method as recited in claim 13, the method comprising:
shutting down power to at least one vehicle system in response to the sensed amount of time being above a predefined threshold time.

15. The method as recited in claim 14, wherein the predefined threshold time is about 5 seconds.

16. The method as recited in claim 15, wherein the predefined threshold speed is about 3 km/h.

17. The method as recited in claim 11, wherein the predefined threshold speed is about 3 km/h.

18. The method as recited in claim 10, wherein the parameter is engine torque.

19. The method as recited in claim 10, wherein the parameter is RPM.

20. The method as recited in claim 10, wherein the parameter is transmission gear status.
